(19) United States
(12) Patent Application Publication
(10) Pub. No.: US 2012/0219896 A1
(43) Pub. Date: Aug. 30, 2012

(54) ELECTROSTATIC IMAGE FORMING TONER AND RESIN FOR TONER

(76) Inventors: Daisuke Asahina, Shizuoka (JP); Tsuyoshi Sugimoto, Shizuoka (JP); Masaki Watanabe, Shizuoka (JP); Rintaro Takahashi, Miyagi (JP); Hiroshi Yamashita, Shizuoka (JP); Satoyuki Sekiguchi, Shizuoka (JP)

(21) Appl. No.: 13/399,346

(22) Filed: Feb. 17, 2012

(30) Foreign Application Priority Data
Feb. 28, 2011 (JP) 2011-041922
Apr. 12, 2011 (JP) 2011-088036

(51) Int. Cl. G03G 9/16; C08L 67/02

(52) U.S. Cl. 430/109.4; 525/444

(57) ABSTRACT

An electrostatic image forming toner including: a colorant; a binder resin; and a releasing agent, wherein the binder resin contains at least two types of polyester resins A and B, wherein a difference of (T1/2−Tg) is 65° C. or more but less than 90° C., where T1/2 denotes a softening point of the electrostatic image forming toner and Tg denotes a glass transition temperature of the electrostatic image forming toner, and wherein the electrostatic image forming toner has a TMA compressive deformation rate (TMA %) at 50° C. which is 5% or less.

### BACKGROUND OF THE INVENTION

1. Field of the Invention

The present invention relates to an electrostatic image developing toner applied to an electrophotographic image forming apparatus such as a copier, a printer, and a facsimile; and to a resin for use in a toner, the resin being used for the electrostatic image developing toner.

2. Description of the Related Art

Recently, environment-friendly products have become popular, so that a technique of fixing a toner with low energy has been desired. There are a variety of techniques as means for satisfying the foregoing desire, but strong demand has arisen for an electrostatic image developing toner capable of being fixed at lower temperatures.

As a measure to lower the fixing temperature of a toner, a technique of lowering the glass transition temperature of a toner binder is commonly employed. However, if the glass transition temperature is made too low, aggregation (blocking) of a powder is more likely to occur. Such aggregation of toner particles in the image forming apparatus may adversely affect the operation of the developing device, so that it may be impossible for the developing device to operate. Even if the developing device's operation is not stopped, such toner aggregation in the toner container prevents a toner from being supplied, whereby the toner concentration decreases to potentially form abnormal images. The durability of the toner on the fixed image surface becomes also degraded. This fixed image easily melts to be transferred, and adheres to another recording medium superposed thereon, resulting in that the image cannot be stored for a long period of time in some cases. Suppressing the occurrence of such blocking is improving blocking resistance of the toner. The glass transition temperature is a design point of a toner binder. Nevertheless, the method of simply lowering the glass transition temperature has not yet been able to produce a toner that enables fixing at a temperature lower than the currently employed fixing temperature.

As a measure to achieve both desired blocking resistance and desired low-temperature fixing property, a method using a crystalline resin as a toner binder has traditionally been known. This method, however, has a problem that hot offset occurs due to shortage of elasticity at the time of melting.

Also as a measure to achieve both desired blocking resistance and desired low-temperature fixing property, a toner having a shell obtained by using a melt suspension method or an emulsion aggregation method has been proposed (see, for example, Japanese Patent Application Laid-Open (JP-A) Nos. 2007-70621 and 2004-191927). However, these techniques are still insufficient to obtain good blocking resistance while keeping low temperature fixation.

Furthermore, there has been proposed a technique focusing on a crystalline resin to solve this problem (see, for example, JP-A No. 2010-217849). Such a crystalline resin is susceptible to external conditions (e.g., heat history during production, storage and fixation, and partial phase mixing) and is unstable in its crystalline structure. Thus, the crystalline resin poses a problem in that it degrades the formed toner in various properties, blocking resistance and image stability.

### SUMMARY OF THE INVENTION

The present invention has been made under such circumstances, and aims to solve the above-described problems pertinent the art and achieve the following objects. The present invention aims to provide an electrostatic image forming toner having excellent low-temperature fixing property, blocking resistance, and color development property, and a resin for use in a toner, the resin being used for the electrostatic image developing toner.

Means for solving the above-described problems are as follows.

Specifically, an electrostatic image forming toner of the present invention includes:

a colorant;

a binder resin; and

a releasing agent,

wherein the binder resin contains at least two types of polyester resins A and B,

wherein a difference of (T1/2−Tg) is 65° C. or more but less than 90° C., where T1/2 denotes a softening point of the electrostatic image forming toner and Tg denotes a glass transition temperature of the electrostatic image forming toner, and

wherein the electrostatic image forming toner has a TMA compressive deformation rate (TMA %) at 50° C. which is 5% or less.

Also in the electrostatic image forming toner of the present invention, the polyester resin A contains a nonlinear reactive precursor “a” and a curing agent, the polyester resin B is a linear polyester resin, and a difference of (bTg−aTg) is 40° C. or more but less than 95° C., where aTg denotes a glass transition temperature of an active end capped product of the reactive precursor “a” and bTg denotes a glass transition temperature of the polyester resin B.

Also in the electrostatic image forming toner of the present invention, the polyester resin A contains 5-sulfoisophtalic acid backbone in proportion of 0.1 mol % to 10 mol % of the total acid components.

Also in the electrostatic image forming toner of the present invention, an amount of the polyester resin A in the binder resin is 1% by mass or more and 30% by mass or less.

A resin for use in a toner of the present invention includes: at least two types of polyester resins A and B, wherein the polyester resin A includes a nonlinear reactive precursor “a” and a curing agent, wherein the polyester resin B is a linear polyester resin, and wherein a difference of (bTg−aTg) is 40° C. or more but less than 95° C., where aTg denotes a glass transition temperature of an active end capped product of the reactive precursor “a” and bTg denotes a glass transition temperature of the polyester resin B.

Also in the resin for use in a toner of the present invention, an amount of the polyester resin A in the binder resin is 1% by mass or more and 30% by mass or less.

According to the present invention, the problems pertinent in the art can be solved and the following effects can be achieved.

An electrostatic image forming toner of the present invention can achieve simultaneously two paradoxical properties; i.e., low-temperature fixing property and blocking resistance, because the electrostatic image forming toner can be fixed at a low temperature while exhibiting blocking resistance until just before application of heat for fixing, and softening rapidly upon application of heat.

The present invention can also provide a resin for use in a toner, the resin being capable of being used for producing a toner and achieving simultaneously two paradoxical properties; i.e., low-temperature fixing property and blocking resistance, because the toner can be fixed at a low temperature while exhibiting blocking resistance until just before application of heat for fixing, and softening rapidly upon application of heat.

### DETAILED DESCRIPTION OF THE INVENTION

The best mode for carrying out the present invention will now be described. Those skilled in the art shall be able to make easily numerous variations and modifications to the present invention without departing from the scope of the present invention. All such variations and modifications are intended to be within the scope of the present invention as defined in the appended claims. The following description is intended to be the best mode for carrying out the present invention and should not be considered as limiting the scope of the present invention.

An electrostatic image forming toner (hereinafter may be referred to as simply “toner”) contains as a binder resin at least two types of polyester resins A and B.

Particularly, at least two types of polyester resins include a nonlinear non-crystalline polyester resin A and a linear non-crystalline polyester resin B. It is preferable that the nonlinear non-crystalline polyester resin A be completely compatible with the linear non-crystalline polyester resin B. The nonlinear reactive polyester resin A is preferably contained because it increases design options in terms of, for example, molecular weight, and thermal property of a resin. The polyester resin A having an ultra-low glass transition temperature and high melt viscosity enables the toner to have both low-temperature fixing property and blocking resistance (may be referred to as “storageability,” meaning the toner cannot be easily deformed) although a softening point of the resin as a whole decreases. Accordingly, the complexation of other non-crystalline polyester resin B with the nonlinear non-crystalline polyester resin A having an ultra-low glass transition temperature and high melt viscosity in a compatible state enables the toner to have simultaneously two paradoxical properties, low-temperature fixing property and blocking resistance.

A polyester resin A now will be explained.

The polyester resin A is not particularly limited, and may be appropriately selected depending on the intended purpose, but is preferably a nonlinear non-crystalline polyester resin A.

The nonlinear non-crystalline polyester resin A includes a nonlinear reactive precursor “a” and a curing agent.

The reactive precursor “a” is a polyester having a reaction activity point at its end such as isocyanate, epoxy, and carbodiimide, with a polyester based polyurethane which has an NCO end group being particularly preferable.

Any conventionally known polyvalent alcohol component may be used in the polyester alone and/or in combination with other polyvalent alcohols, but aliphatic diols such as 3-methyl-1,5-pentanediol and neopentylglycol is preferably used in terms of blocking resistance, storageability of images, and low-temperature fixing property. Any conventionally known acid component may be used in the polyester alone and/or in combination with other acids, but terephtalic acid, isophtalic acid, phtalic anhydride, adipic acid, sebacic acid, and dodecane dicarboxylic acid are preferably used in terms of cost.

Any conventionally known tri- or higher-valent polyfunctional component may be used to form a nonlinear structure, i.e., branch structure, but alcohols such as trimethylolpropane, and acids such as trimellitic anhydride are preferably used in terms of cost.

A diisocyanate as an isocyanate component includes aromatic diisocyanates having 6 to 20 carbon atoms (exclusive of a carbon in an NCO group; the same applies to the following description), aliphatic diisocyanates having 2 to 18 carbon atoms, alicyclic diisocyanates having 4 to 15 carbon atoms, araliphatic diisocyanates having 8 to 15 carbon atoms, and modified products of these diisocyanates (e.g., modified diisocyanates containing urethane group, carbodiimide group, allophanate group, urea group, biuret group, urethodione group, urethoimine group, and isocyanurate group and oxazolidone group) and a mixture of any two or more thereof. A tri- or higher-valent polyisocyanate may be used in combination with above-mentioned diisocyanates, if necessary.

Examples of the aromatic diisocyanates (including tri- or higher-valent polyisocyanates) include 1,3- and/or 1,4-phenylene diisocyanate, 2,4- and/or 2,6-tolylene diisocyanate (TDI), crude TDI, 2,4′- and/or 4,4′-diphenylmethane diisocyanate (MDI), crude MDI [phosgenide of crude diaminophenylmethane [a condensation product of formaldehyde with aromatic amine (aniline) or a mixture thereof; a mixture of diaminodiphenylmethane with a small amount (e.g., 5% by mass to 20% by mass) of tri- or higher-functional polyamine]: polyallyl polyisocyanate (PAPI)], 1,5-naphthylene diisocyante, 4,4′,4″-triphenylmethane triisocyanate, and m- and p-isocyanatophenylsulfonyl isocyanate.

Examples of the aliphatic diisocyanates (including tri- or higher-valent polyisocyanates) include ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatoethyl)fumarate, bis(2-isocyanatoethyl)carbonate, and 2-isocyanatoethyl-2,6-diisocyanatohexanoate.

Examples of the alicyclic diisocyanates include isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, 2,5- and/or 2,6-norbornane diisocyanate.

Examples of the araliphatic diisocyanates include m- and/or p-xylylene diisocyanate (XDI) and α,α,α′,α′-tetramethylxylylene diisocyanate (TMXDI).

Examples of the modified products of the diisocyanates include urethane group-containing modified product, carbodiimide group-containing modified product, allophanate group-containing modified product, urea group-containing modified product, biuret group-containing modified product, urethodione group-containing modified product, urethoimine group-containing modified product, isocyanurate group-containing modified product and oxazolidone group-containing modified product, more particularly, modified diisocyanates such as modified MDI (e.g., urethane-modified MDI, carbodiimide-modified MDI, and trihydrocarbylphosphate-modified MDI) and urethane-modified TDI, as well as mixtures of two or more thereof (e.g., modified MDI used in combination with urethane-modified TDI (isocyanate-containing prepolymer)). Among these diisocyanates, aromatic diisocyanates having 6 to 15 carbon atoms, aliphatic diisocyanates having 4 to 12 carbon atoms, and alicyclic diisocyanates having 4 to 15 carbon atoms are preferably used, with TDI, MDI, HDI, hydrogenated MDI, and IPDI being particularly preferable.

Any conventionally known amine compound may be suitably used as a curing agent.

Examples of diamines (including optionally used tri- or higher-valent polyamines) include aliphatic diamines (C2-C18) and aromatic diamines (C6-C20).

Examples of aliphatic diamines (C2-C18) include:

[1] aliphatic diamines (C2-C6 alkylenediamines (e.g., ethylenediamine, propylenediamine, trimethylenediamine, tetramethylenediamine, and hexamethylenediamine), polyalkylene (C2-C6) diamines (e.g., diethylenetriamine, iminobispropylamine, bis(hexamethylene)triamine, triethylenetetramine, tetraethylenepentamine and pentaethylenehexamine));

[2] alkyl (C1-C4)- or hydroxyalkyl (C2-C4)-substituted aliphatic diamines described above (e.g., dialkyl (C1-C3) aminopropylamine, trimethylhexamethylenediamine, aminoethylethanolamine, 2,5-dimethyl-2,5-hexamethylenediamine, and methyliminobispropylamine);

[3] alicycle- or heterocycle-containing aliphatic diamines (e.g., alicyclic diamines (C4-C15) (e.g., 1,3-diaminocyclohexane, isophoronediamine, menthenediamine, 4,4′-methylenedicyclohexanediamine (hydrogenated methylenedianiline)), and heterocyclic diamines (C4-C15) (e.g., piperazine, N-aminoethylpiperazine, 1,4-diaminoethylpiperazine, 1,4-bis(2-amino-2-methylpropyl)piperazine), and 3,9-bis(3-aminopropyl)-2,4,8,10-tetraoxaspiro[5,5]undecane); and

[4] aromatic ring-containing aliphatic amines (C8-C15) (e.g., xylylenediamine and tetrachloro-p-xylylenediamine).

Examples of aromatic diamines (C6-C20) include:

[1] unsubstituted aromatic diamines (e.g., 1,2-, 1,3- and 1,4-phenylenediamine, 2,4′- and 4,4′-diphenylmethanediamine, crude diphenylmethanediamine (polyphenylpolymethylenepolyamine), diaminodiphenyl sulfone, benzidine, thiodianiline, bis (3,4-diaminophenyl) sulfone, 2,6-diaminopyridine, m-aminobenzylamine, triphenylmethane-4,4′,4″-triamine, and naphthylenediamin);

[2] aromatic diamines having a nuclear-substituting alkyl group (e.g., C1-C4 alkyl such as methyl, ethyl, n- and iso-propyl, and butyl) (e.g., 2,4- and 2,6-tolyelendiamine, crude tolylenediamine, diethyltolylenediamine, 4,4′-diamino-3,3′-dimethyldiphenylmethane, 4,4′-bis(o-toluidine), dianisidine, diaminoditolylsulfone, 1,3-dimethyl-2,4-diaminobenzene, 1,3-dimethyl-2,6-diaminobenzene, 1,4-diisopropyl-2,5-diaminobenzene, 2,4-diaminomesitylene, 1-methyl-3,5-diethyl-2,4-diaminobenzene, 2,3-dimethyl-1,4-diaminonaphthalene, 2,6-dimethyl-1,5-diaminonaphthalene, 3,3′,5,5′-tetramethylbenzidine, 3,3′,5,5′-tetramethyl-4,4′-diaminodiphenylmethane, 3,5-diethyl-3′-methyl-2′, 4-diaminodiphenylmethane, 3,3′-diethyl-2,2′-diaminodiphenylmethane, 4,4′-diamino-3,3′-dimethyldiphenylmethane, 3,3′,5,5′-tetraethyl-4,4′-diaminobenzophenone, 3,3′,5,5′-tetraethyl-4,4′-diaminodiphenylether, and 3,3′,5,5′-tetraisopropyl-4,4′-diaminodiphenyldiphenyl), and mixtures of isomer thereof in various proportions;

[3] aromatic diamines having a nuclear-substituting electron attractive group (e.g., halogen such as Cl, Br, I, and F; alkoxy group such as methoxy and ethoxy; and nitro group) (e.g., methylene bis-o-chloroaniline, 4-chloro-o-phenylenediamine, 2-chloro-1,4-phenylenediamine, 3-amino-4-chloroaniline, 4-bromo-1,3-phenylenediamine, 2,5-dichloro-1,4-phenylenediamine, 5-nitro-1,3-phenylenediamine, 3-dimethoxy-4-aminoaniline; 4,4′-diamino-3,3′-dimethyl-5,5′-dibromo-diphenylmethane, 3,3′-dichlorobenzidine, 3,3′-dimethoxybenzidine, bis(4-amino-3-chlorophenyl)oxide, bis(4-amino-2-chlorophenyl)propane, bis(4-amino-2-chlorophenyl)sulfone, bis(4-amino-3-methoxyphenyl)decane, bis(4-aminophenyl)sulfide, bis(4-aminophenyl)telluride, bis(4-aminophenyl)selenide, bis(4-amino-3-methoxyphenyl)disulfide, 4,4′-methylenebis(2-iodoaniline), 4,4′-methylenebis(2-bromoaniline), 4,4′-methylenebis(2-fluoroaniline), and 4-aminophenyl-2-chloroaniline); [4] secondary amino group-containing aromatic dimines (obtained by replacing some or all of —NH₂ groups in the aromatic diamines [1] to [3] with —NH—R′ groups (wherein R′ represents an alkyl group such as a lower alkyl group; e.g., methyl and ethyl) (e.g., 4,4′-di(methylamino)diphenylmethane, and 1-methyl-2-methylamino-4-aminobenzene).

The diamine components include, other than above-mentioned diamines, low molecular-weight polyamide polyamines obtained by condensation of polyamide polyamines (dicarboxylic acids (e.g., dimer acid) with excess (that is, 2 or more moles per mole of an acid) polyamines (e.g., alkylenediamines and polyalkylenepolyamines mentioned above); and polyether polyamines (e.g., hydrides of cyanoethylation products of polyether polyols (e.g., polyalkylene glycol)).

A polyester resin B now will be explained.

The polyester resin B is not particularly limited, and may be appropriately selected depending on the intended purpose, but is preferably a linear non-crystalline polyester resin B, more preferably a non-crystalline unmodified polyester resin.

An alcohol component used in the non-crystalline polyester resin B includes bivalent alcohols (diols). Examples of the bivalent alcohols include alkylene glycols having 2 to 36 carbon atoms (e.g., ethylene glycol, 1,2-propylene glycol, 1,3-propylene glycol, 1,4-butylene glycol, and 1,6-hexanediol); alkylene ether glycols having 4 to 36 carbon atoms (e.g., diethylene glycol, triethylene glycol, dipropylene glycol, polyethylene glycol, polypropylene glycol, and polypropylene glycol); alicyclic diols having 6 to 36 carbon atoms (e.g., 1,4-cyclohexanedimethanol, and hydrogenated bisphenol A); adducts (addition molar number of 1 to 30) to the alicyclic diols of alkylene oxides having 2 to 4 carbon atoms [e.g., ethylene oxide (hereinafter, abbreviated as EO), propylene oxide (hereinafter, abbreviated as PO), and butylene oxide (hereinafter, abbreviated as BO)]; adducts (addition molar number of 2 to 30) of alkylene oxides having 2 to 4 carbon atoms (e.g., EO, PO, and BO) to bisphenols (e.g., bisphenol A, bisphenol F, and bisphenol S).

In addition to the bivalent diols, tri- or higher-valent (tri- to octa-valent or higher-valent) alcohol components may be contained. Examples of the tri- or higher-valent alcohols include tri- to octa-valent or higher-valent aliphatic alcohols having 3 to 36 carbon atoms (e.g., alkane polyols and intramolecular or intermolecular dehydrate thereof such as glycerin, triethylolethane, trimethylolpropane, pentaerythritol, sorbitol, sorbitan, polyglycerin, and dipentaerythritol; sugars and derivatives thereof such as sucrose and methylglucoside); adducts (addition molar number of 1 to 30) to the above-mentioned aliphatic polyvalent alcohols of alkylene oxides having 2 to 4 carbon atoms (e.g., EO, PO, and BO); adducts (addition molar number 2 to 30) of alkylene oxides having 2 to 4 carbon atoms to trisphenols (e.g., trisphenol PA); and adducts (addition molar number of 2 to 30) of alkylene oxides having 2 to 4 carbon atoms (e.g., EO, PO, and BO) to novolak resins (e.g., phenol novolak and cresol novolak; average polymerization degree of 3 to 60).

An carboxylic acid component used in the non-crystalline polyester resin B includes bivalent carboxylic acids (dicarboxylic acids). Examples of the dicarboxylic acids include alkanedicarboxylic acids having 4 to 36 carbon atoms (e.g., succinic acid, adipic acid, and sebacic acid) and alkenylsuccinic acid (e.g., dodecenylsuccinic acid); alicyclic dicarboxylic acids having 4 to 36 carbon atoms (e.g., dimmer acid (dimerized linoleic acid)); alkenedicarboxylic acids having 4 to 36 carbon atoms (e.g., maleic acid, fumaric acid, citraconic acid, and mesaconic acid); aromatic dicarboxylic acids having 8 to 36 carbon atoms (e.g., phthalic acid, isophthalic acid, terephthalic acid or derivatives thereof, and naphthalenedicarboxylic acid). Among them, preferable are alkenedicarboxylic acids having 4 to 20 carbon atoms and aromatic dicarboxylic acids having 8 to 20 carbon atoms. As polycarboxylic acid components, acid anhydrides or lower alkyl (having 1 to 4 carbon atoms) esters (e.g., methyl ester, ethyl ester, and isopropyl ester) of above-mentioned polycarboxylic acids may be used.

In addition to the bivalent alcohols, tri- or higher-valent (tri- to hexa- or higher-valent) carboxylic acid components may be contained. Examples of the tri- or higher-valent carboxylic acids include aromatic polycarboxylic acids having 9 to 20 carbon atoms (e.g., trimellitic acid and pyromellitic acid); and vinyl polymers of unsaturated carboxylic acids [number average molecular weight (hereinafter abbreviated as “Mn”) measured by gel permeation chromatography (GPC): 450 to 10,000] (e.g., styrene/maleic acid copolymer, styrene/acrylic acid copolymer, α-olefin/maleic acid copolymer, and styrene/fumaric acid copolymer). Among them, aromatic polycarboxylic acids having 9 to 20 carbon atoms are preferable, trimellitic acid and pyromellitic acid are more preferable. As tri- or higher valent polycarboxylic acids, acid anhydrides or lower alkyl (having 1 to 4 carbon atoms) esters (e.g., methyl esters, ethyl esters, and isopropyl esters) of above-mentioned polycarboxylic acids may be used.

Accordingly, a toner is produced using, as a major binder resin, the nonlinear non-crystalline polyester resin A having a non-reactive end and the linear non-crystalline polyester resin B.

A method for producing a toner includes a kneading and pulverizing method in which a binder resin is melt-kneaded with a colorant, and then pulverized and further classified. A method for producing a toner by granulating toner particles in a solvent such as an aqueous phase includes a suspension polymerization method, and an emulsification-polymerization and aggregation method.

In the suspension polymerization method, for example, a monomer, a polymerization initiator, a colorant, a releasing agent are added to an aqueous phase containing a dispersion stabilizer while stirring the aqueous phase to form oil droplets, and then a temperature of the oil droplets is raised and subjected to a polymerization reaction, thereby obtaining toner particles.

In the emulsification-polymerization and aggregation method, for example, toner particles are produced by aggregating and thermally fusing fine particles obtained by emulsifying and dispersing in an aqueous phase a polyester resin used as a binder resin before desolventization, with a dispersion prepared by dispersing in the aqueous phase a colorant, a releasing agent (wax).

A toner of the present invention may be produced using any method as long as using the resin for the toner described above.

A thermal property of a toner of the present invention now will be explained.

A toner of the present invention must have a difference of (T1/2−Tg) is 65° C. or more but less than 90° C., where T1/2 denotes a softening point of the toner and Tg denotes a glass transition temperature of the toner. A toner having a difference between a softening point and a glass transition temperature of 90° C. or more may have insufficient thermoplasticity to achieve low-temperature fixing property. A toner having a difference between a softening point and a glass transition temperature of less than 65° C. may have low melt viscosity, thereby deteriorating blocking resistance as a toner as well blocking resistance as a stack and a document due to preheating when copying many papers at once.

In addition to satisfying the condition described above, a toner of the present invention must have TMA compressive deformation rate (TMA %) at 50° C. of 5% or less. This means that when TMA % is more than 5%, a toner can be easily deformed even at 50° C. when applying external force against it, and has a poor storageability under a dynamic condition even though it has an excellent static storageability determined by a penetration rate test and thus blocking resistance of a toner is low. That is, a toner having TMA compressive deformation rate (TMA %) at 50° C. of 5% or less is not preferable because the toner easily adheres to each other and leads to low transportability and transferability, directly causing failure in image quality when the toner is transported and stored in a warehouse in summer or exposed to high temperature in a copier. The TMA % at 50° C. is preferably 3% or less.

A toner of the present invention must have a difference of (bTg−aTg) between a glass transition temperature of an end capped product of a nonlinear reactive precursor “a” in a non-crystalline polyester resin A (aTg) and a glass transition temperature of a linear non-crystalline polyester resin B (bTg) is 40° C. or more but less than 95° C. The difference (bTg−aTg) of less than 40° C. is not preferable because a plasticization effect from a non-crystalline polyester resin A cannot be obtained and the toner cannot fixed at low temperature, so that the object of the present invention cannot be achieved. On the other hand, when the difference (bTg−aTg) is more than 95° C., low-temperature fixing property can be achieved, but blocking resistance of the toner may be deteriorated due to excess plasticization, causing poor image quality.

A toner of the present invention contains 5-sulfoisophtalic acid backbone in proportion of 0.1 mol % to 10 mol %, preferably 7 mol % or less, more preferably 5 mol % or less of the total acid components in the polyester resin A. This improves dispersibility and colorability of a pigment. When the content of the sulfoisophtalic acid backbone based on the total of acid components is less than 0.1 mol %, the sulfoisophtalic acid may not exert an effect thereof. When the content of the sulfoisophtalic acid backbone based on the total of acid components is more than 10 mol %, quality stability and productivity of a toner may be significantly decreased, because polyester becomes gelatinous due to excess increasing of the melt viscosity and solution viscosity upon prepolymerizarion of polyester. Additionally, an improvement of hydrophilicity may deteriorate storageability of a toner.

In a toner of the present invention, a content of a non-crystalline polyester resin A in a binder resin is 1% by mass or more and 30% by mass or less. This enables the toner to achieve both blocking resistance and low-temperature fixing property, because the toner do not melt under a toner-storage environment and when stirred in a developing apparatus but viscoelasticity thereof rapidly decreases when a temperature of the toner falls within a predetermined range. Therefore, when an amount of the non-crystalline polyester resin A in the toner is less than 1% by mass, the toner is not aggregate because of good blocking resistance, but has poor low-temperature fixing property. When a content of the non-crystalline polyester resin A in the toner is more than 30% by mass, the toner has good low-temperature fixing property but has poor blocking resistance, resulting in an aggregate of a toner in an image forming apparatus.

Additionally, a toner of the present invention may include the following materials.

A toner of the present invention can be produced by mixing or polymerizing with a binder resin and a colorant, and if necessary, may contain an additive such as a charge control agent, a release agent, and a fluidizing agent.

As the colorant, all kinds of dyes and pigments used as a colorant for a toner may be used. Examples thereof are carbon black, iron black, Sudan black SM, First Yellow G, Benzidine Yellow, Solvent Yellow (21, 77, 114), Pigment Yellow (12, 14, 17, 83), Indian First Orange, Irgasin Red, p-Nitoaniline Red, Toluidine Red, Solvent Red (17, 49, 128, 5, 13, 22, 48.2), Disperse Red, Carmine FB, Pigment Orange R, Lake Red 2G, Rhodamine FB, Rhodamine B Lake, Methyl Violet B Lake, Phthalocyanine Blue, Solvent Blue (25, 94, 60, 15.3), Pigment Blue, Brilliant Green, Phthalocyanine Green, Oil Yellow GG, Kayaset YG, Orazol Brawn B, and Oil Pink OP and these colorants may be used alone or in a mixture of two or more thereof. Further, if necessary, a magnetic powder which also functions as a colorant (a powder of a ferromagnetic metal such as iron, cobalt, and nickel or a compound such as magnetite, hematite, and ferrite) may be contained. A content of the colorant is preferably from 0.1 parts to 40 parts and more preferably from 0.5 parts to 10 parts relative to 100 parts of the toner binder of the present invention. In the case of using the magnetic powder, it is preferably from 20 parts to 150 parts and more preferably from 40 parts to 120 parts. The term “part” means part by mass throughout this specification.

As a release agent, those having a softening point from 50° C. to 170° C. are preferable and examples thereof include polyolefin waxes, natural waxes (e.g., carnauba wax, montan wax, paraffin wax, and rice wax), aliphatic alcohols having 30 to 50 carbon atoms (e.g., triacontanol), fatty acids having 30 to 50 carbon atoms (e.g., triacontanecarboxylic acid), and mixtures thereof. Examples of the polyolefin waxes are (co)polymers of olefins (e.g., ethylene, propylene, 1-butene, isobutylene, 1-hexene, 1-dodecene, 1-octadecene, and mixtures thereof) including copolymerized polyolefins and thermal degradated polyolefins; oxides of olefin (co)polymers by oxygen or oxone; maleic acid-modified products of olefin (co)polymers (e.g., products modified with maleic acid and its derivatives (e.g., maleic anhydride, monomethyl maleate, monobutyl maleate, and dimethyl maleate)); copolymers of olefin with unsaturated carboxylic acids (e.g., (meth)acrylic acid, itaconic acid, and maleic anhydride) and/or unsaturated carboxylic acid alkyl esters (e.g., (meth)acrylic acid alkyl (alkyl having 1 to 18 carbon atoms) esters and maleic acid alkyl (alkyl having 1 to 18 carbon atoms) esters); and polymethylene (e.g., Fischer-Tropsch waxes such as sasol waxes), metal salts of fatty acids (e.g., calcium stearate), fatty acid esters (e.g., behenyl behenate).

Examples of the charge control agent include Nigrosine dyes, triphenylmethane type dyes having a tertiary amine as a side chain, quaternary ammonium salts, polyamine resins, imidazole derivatives, quaternary ammonium salt-containing polymers, metal-containing azo dyes, copper-phthalocyanine dyes, metal salicylate, boron complexes of benzylic acid, sulfonic acid group-containing polymers, fluorine-containing polymers, halogen-substituted aromatic ring-containing polymers, metal complexes of alkyl derivatives of salicylic acid, and cethyltrimethylammonium bromide.

Examples of the fluidizing agent include colloidal silica, alumina powder, titanium oxide powder, calcium carbonate powder, barium titanate, magnesium titanate, calcium titanate, strontium titanate, zinc oxide, silica sand, clay, mica, wollastonite, diatomaceous earth, chromium oxide, cerium oxide, red iron oxide, antimony trioxide, magnesium oxide, zirconium oxide, barium sulphate, and barium carbonate.

With respect to a composition ratio of a toner of the present invention, based on the toner weight (hereinafter the unit “%” in this section means “% by mass”), a toner binder is preferably contained from 30% to 97%, more preferably from 40% to 95%, and even more preferably from 45% to 92%; a colorant is preferably contained from 0.05% to 60%, more preferably from 0.1% to 55%, and even more preferably from 0.5% to 50%; and among the additives, a release agent is preferably contained from 0% to 30%, more preferably from 0.5% to 20%, and even more preferably from 1% to 10%; a charge control agent is preferably contained from 0% to 20%, more preferably from 0.1% to 10%, and even more preferably from 0.5% to 7.5%; a fluidizing agent is preferably contained from 0% to 10%, more preferably from 0% to 5%, and more preferably from 0.1% to 4%. The total content of these additives is preferably from 3% to 70%, more preferably from 4% to 58%, and even more preferably from 5% to 50%. A composition ratio of the toner within the above-mentioned ranges allows a toner with excellent electrostatic property to be easily obtained.

A toner of the present invention may be obtained by any conventionally known method such as a kneading and pulverizing method, an emulsifying phase-inversion method, and a polymerizing method as described above. For example, in the case of obtaining a toner by the kneading and pulverizing method, components of the toner other than a fluidizing agent are dry-blended, melt-kneaded, roughly grinded, and finally finely granulated by, for example, a jet mill pulverizer and further classified to obtain fine particles having a volume average particle size (D50) of preferably from 5 μm to 20 μm. Thereafter, a fluidizing agent is added to the fine particles to obtain a toner. The particle size (D50) is measured by a Coulter Counter (for example, available from Coulter Co. under the trade name of MULTISIZER III).

In the case of obtaining a toner by the emulsifying phase-inversion method, components of the toner other than a fluidizing agent are dissolved or dispersed in an organic solvent, emulsified by, for example, adding water, and then separated and classified. The method using organic fine particles described in JP-A No. 2002-284881 can be used.

A volume average particle size of the toner is preferably from 3 μm to 15 μm.

The toner, if necessary, may be mixed with carrier particles (e.g., iron powder, glass beads, nickel powder, ferrite, magnetite and ferrite of which surface is coated with a resin (e.g., acrylic resin and silicone resin)) to be used as a developing agent for an electric latent image. An electric latent image can also be formed by bringing into friction with a charging blade in place of the carrier particles. The electric latent image is fixed on a support (e.g., paper and a polyester film) by any known heat roll fixing method.

### EXAMPLES

Hereinafter, the present invention will be further described referring to the following Examples; however, the present invention should not be construed as limiting to these Examples. In the following description, “%” means “% by mass.”

### <Evaluation>

A toner and a developing agent containing it was produced by the following method and evaluated as follows.

### <Preparation of Toner>

### —Synthesis of Ketimine—

To a reaction container equipped with a stirrer and a thermometer, were added 170 parts of isophorone diamine and 75 parts of methyl ethyl ketone, and the mixture was allowed to react at 50° C. for 5 hours to obtain [Ketimine compound 1]. The [Ketimine compound 1] had an amine value of 418.

### —Synthesis of Master Batch (MB)—

One thousand and two hundred parts of water, 540 parts of carbon black (Printex 35, manufactured by Evonik Degussa Japan Co. Ltd.; DBP Oil absorption amount=42 mL/100 mg, pH 9.5), and 1,200 parts of the non-crystalline polyester resin A-1 were mixed in a Henschell mixer (manufactured by Mitsui Mining & Smelting Co., Ltd.), and the resultant mixture was kneaded with a two roll mill at 150° C. for 30 min, rolled and cooled, and then pulverized with a pulverizer to obtain [Master batch 1].

### —Production of Pigment/Wax Dispersion—

To a container equipped with a stirrer and a thermometer, were added 378 parts of [Resin B-1], 50 parts of paraffin wax as a releasing agent 1 (manufactured by NIPPON SEIRO CO., LTD., HNP-9, hydrocarbon-based wax, melting point: 75° C., SP value: 8.8), 22 parts of CCA (metal salicylate complex: E-84, manufactured by Orient Chemical Industries Co., Ltd.), and 947 parts of ethyl acetate. Subsequently, a temperature of the mixture was increased to 80° C. while stirring, kept at 80° C. for 5 hours, and then decreased to 30° C. in 1 hour. Then, 500 parts of [Master batch 1] and 500 parts of ethyl acetate were placed in the container, and mixed for 1 hour to obtain [Raw material solution].

One thousand and three hundred twenty four parts of [Raw material solution] was transferred to a container, and dispersion was carried out by means of a bead mill (Ultraviscomill, manufactured by Aimex Co., Ltd.) under the following conditions: solution sending speed: 1 kg/hr, disk peripheral velocity: 6 m/sec; filling: 80% by volume of the container with 0.5 mm zirconia beads; and the number of pass: 3. Next, 1,042.3 parts of ethyl acetate solution containing 65% [non-crystalline polyester A] was added to the resultant dispersion and subjected to the above-mentioned dispersion treatment using the bead mill under the same conditions as above except that the number of pass was 1 to obtain [Pigment/wax dispersion]. The [Pigment/wax dispersion] had a solid content (at 130° C., for 30 minutes) of 50%.

### —Preparation of Oil Phase—

Six hundred sixty four parts of [Pigment/wax dispersion], 150 parts of [Prepolymer] and 4.6 parts of [Ketimine compound] were placed in a container, and mixed with TK HOMO MIXER (manufactured by PRIMIX Corporation) at 5,000 rpm for 1 minute to obtain [Oil phase].

### —Synthesis of Organic Fine Particle Emulsion (Fine Particle Dispersion)—

To a reaction container equipped with a stirrer and a thermometer, 683 parts of water, 11 parts of sodium salt of sulfate ester of an ethyleneoxide adduct of methacrylic acid (ELEMINOR RS-30, manufactured by Sanyo Chemical Industries, Ltd), 138 parts of styrene, 138 parts of methacrylic acid, and 1 part of ammonium persulfate were added, and the resultant mixture was stirred for 15 minutes at 400 rpm to obtain a white milky emulsion. The white milky emulsion was heated so as to be a temperature of a system of 75° C., and allowed to react for 5 hours. Subsequently, further 30 parts of a 1% ammonium persulfate aqueous solution were added, and the resultant mixture was matured at 75° C. for 5 hours to obtain [Fine particle dispersion] which was an aqueous dispersion of vinyl resin (copolymer of styrene, methacrylic acid, and sodium salt of sulfate ester of ethyleneoxide adduct of methacrylic acid). The [Fine particle dispersion] had a volume average particle size of 0.14 μm as determined with LA-920 (manufactured by Horiba Seisakusho). A portion of the [Fine particle dispersion] was dried to separate its resin component.

### —Preparation of Water Phase—

Nine hundred ninety parts of water, 83 parts of [Fine particle dispersion], 37 parts of an aqueous solution containing 48.5% sodium dodecyl diphenyl ether disulfonate (ELEMINOR MON-7, manufactured by Sanyo Chemical Industries, Ltd.), and 90 parts of ethyl acetate were mixed and stirred to obtain [Water phase] which was a milky white liquid.

### —Emulsifying/Desolventizing Agent—

To the container containing [Oil phase], 1,200 parts of [Water phase] was added, then the mixture was mixed with TK HOMO MIXER at 13,000 rpm for 20 minutes to obtain [Emulsion slurry].

To a container equipped with a stirrer and a thermometer, the [Emulsion slurry] was loaded, desolventized at 30° C. for 8 hours, and then matured at 45° C. for 4 hours to obtain [Dispersion slurry].

### —Washing and Drying—

One hundred parts of the [Dispersion slurry] was filtered under reduced pressure, and the resultant filter cake was washed and dried as follows:

(1): One hundred parts of ion exchange water were added to the filter cake, and mixed using TK HOMO MIXER (at 12,000 rpm, for 10 minutes) and then filtrated.
(2): One hundred parts of 10% aqueous sodium hydroxide were added to the filter cake of (1), and mixed (at 12,000 rpm, for 30 minutes) using TK HOMO MIXER, and then filtered under reduced pressure.
(3): One hundred parts of 10% hydrochloric acid was added to the filter cake of (2), and mixed using TK HOMO MIXER (at 12,000 rpm, for 10 minutes), and then filtered.
(4): Three hundred parts of ion exchange water were added to the filter cake of (3), and mixed using TK HOMO MIXER (at 12,000 rpm, for 10 minutes), and then filtered. These treatments (1) to (4) were performed twice to obtain [Filter cake 1].

The [Filter cake 1] was dried at 45° C. for 48 hours using an air circulation dryer, and sieved through a mesh with an opening having a size of 75 μm to obtain [Toner].

### Synthesis Example 1

### Synthesis of Nonlinear Polyester Resin A-1

To a reaction container equipped with a cooling tube, a stirrer, and a nitrogen inlet tube, 3-methyl-1,5-pentanediol, terephthalic acid, adipic acid, and trimellitic anhydride were loaded with titanium tetraisopropoxide (1,000 ppm relative to resin components) such that a ratio of OH/COOH was 1.5 and acid components were composed of 90 mol % of terephtalic acid, 17.5 mol % of adipic acid, and 2.5 mol % of trimellitic anhydride. Thereafter, the resultant mixture was heated to 200° C. in about 4 hours, heated to 230° C. in 2 hours, and allowed to react until water no longer drains and then allowed to continue to react for another 5 hours under a reduced pressure (1,334 Pa to 2,000 Pa (10 mmHg to 15 mmHg)) to obtain an intermediate polyester. Then, to a reaction container equipped with a cooling tube, a stirrer, and a nitrogen introduction tube, the intermediate polyester and isophorone diisocyanate with a molar ratio of 2.0 were loaded, diluted with ethyl acetate to 48%, and allowed to react at 100° C. for 5 hours. Table 1 reports the properties of the resulting nonlinear prepolymer.

### Synthesis Example 2

### Synthesis of Nonlinear Polyester Resin A-2

To a reaction container equipped with a cooling tube, a stirrer, and a nitrogen inlet tube, 3-methyl-1,5-pentanediol, terephthalic acid, adipic acid, and trimellitic anhydride were loaded with titanium tetraisopropoxide (1,000 ppm relative to resin components) such that a ratio of OH/COOH was 1.15 and acid components were composed of 2.5 mol % of 5-sulfoisophtalic acid, 45 mol % of isophtalic acid, 50 mol % of adipic acid, and 2.5 mol % of trimellitic anhydride. Thereafter, the resultant mixture was heated to 200° C. in about 4 hours, heated to 240° C. in 2 hours, and allowed to react until water no longer drains and then allowed to continue to react for another 5 hours under a reduced pressure (1,334 Pa to 2,000 Pa (10 mmHg to 15 mmHg)) to obtain an intermediate polyester. Then, to a reaction container equipped with a cooling tube, a stirrer, and a nitrogen introduction tube, the intermediate polyester and isophorone diisocyanate with a molar ratio of 2.0 were loaded, diluted with ethyl acetate to 48%, and allowed to react at 100° C. for 5 hours. Table 1 reports the properties of the resulting nonlinear prepolymer.

### Synthesis Example 3

### Synthesis of Linear Polyester Resin B-1

To a 5 L four-necked flask equipped with a nitrogen inlet tube, a dewatering tube, a stirrer, and a thermocouple, ethylene oxide (2 mol) adduct of bisphenol A/propylene oxide (3 mol) adduct of bisphenol A with a molar ratio of 85/15, and isophtalic acid/adipic acid with a molar ratio of 80/20 were added such that a ratio of OH/COOH was 1.3, and allowed to react with 500 ppm of titanium tetraisopropoxide under normal pressure at 230° C. for 10 hours, and then allowed to continue to react for another 5 hours under a reduced pressure (1,334 Pa to 2,000 Pa (10 mmHg to 15 mmHg)). Next, 30 parts of trimellitic anhydride was added into the flask, and allowed to react under normal pressure at 180° C. for 3 hours to obtain a linear polyester resin B-1. Table 1 reports the properties of the resulting polyester resin B-1.

### Synthesis Example 4

### Synthesis of Linear Polyester Resin B-2

A linear polyester resin B-2 was produced in the same manner as in Synthesis Example 3, except that adipic acid was not added and the number of moles of ethylene oxide (2 mol) adduct of bisphenol A was equal to that of propylene oxide (3 mol) adduct of bisphenol A. Table 1 reports the properties of the resulting polyester resin B-2.

### Synthesis Example 5

### Synthesis of Linear Polyester Resin B-3

A linear polyester resin B-3 was produced in the same manner as in Synthesis Example 3, except that a molar ratio of isophtalic acid to adipic acid was 20/80, and propylene glycol was used as alcohol components instead of propylene oxide (3 mol) adduct of bisphenol A. Table 1 reports the properties of the resulting polyester resin B-3.

### Example 1

A toner was prepared and obtained according to the method described above and using the Resin A-1 resulted from Synthesis Example 1 and the Resin B-1 resulted from Synthesis Example 3. Table 1 reports the properties of the resulting toner. As a result, the high quality toner having both blocking resistance and low-temperature fixing property could be obtained.

### Example 2

A toner was prepared in the same manner as in Example 1, except that the Resin A-1 was changed to a resin prepared in the same manner as in Synthesis Example 1 except for an acid component ratio of terephthalic acid/adipic acid/trimellitic acid=17.5/80/2.5. Table 1 reports the properties of the resulting toner. As a result, the high quality toner having both blocking resistance and low-temperature fixing property could be obtained.

### Example 3

A toner was prepared in the same manner as in Example 1, except that the Resin A-1 was changed to a resin prepared in the same manner as in Synthesis Example 1 except that dodecane diacid was used instead of adipic acid. Table 1 reports the properties of the resulting toner. As a result, the high quality toner having both blocking resistance and low-temperature fixing property could be obtained.

### Example 4

A toner was prepared in the same manner as in Example 1, except that the Resin A-1 was changed to a resin prepared in the same manner as in Synthesis Example 1 except for an acid component ratio of isophthalic acid/trimellitic acid=97.5/2.5. Table 1 reports the properties of the resulting toner. As a result, the high quality toner having both blocking resistance and low-temperature fixing property could be obtained.

### Example 5

A toner was prepared in the same manner as in Example 1, except that the Resin B-1 was changed to the Resin B-2 resulted from Synthesis Example 4. Table 1 reports the properties of the resulting toner. As a result, the high quality toner having both blocking resistance and low-temperature fixing property could be obtained.

### Example 6

A toner was prepared in the same manner as in Example 2, except that the Resin B-1 was changed to the Resin B-2 resulted from Synthesis Example 4. Table 1 reports the properties of the resulting toner. As a result, the high quality toner having both blocking resistance and low-temperature fixing property could be obtained.

### Example 7

A toner was prepared in the same manner as in Example 1, except that the Resin A-1 was changed to the Resin A-2 resulted from Synthesis Example 2. Table 1 reports the properties of the resulting toner. As a result, the high quality toner having all of blocking resistance, low-temperature fixing property, and high colorability could be obtained.

### Example 8

A toner was prepared in the same manner as in Example 1, except that the Resin A-1 was changed to a resin prepared in the same manner as in Synthesis Example 2 except that acid components were composed of 5 mol % of 5-sulfoisophtalic acid, 42.5 mol % of isophtalic acid, 50 mol % of adipic acid, and 2.5 mol % of trimellitic anhydride. Table 1 reports the properties of the resulting toner.

### Comparative Example 1

A toner was prepared in the same manner as in Example 1, except that the Resin A-1 was changed to a resin prepared in the same manner as in Synthesis Example 1 except for an acid component ratio of terephthalic acid/adipic acid/trimellitic acid=18.5/80/5. Table 1 reports the properties of the resulting toner. As a result, the toner could not satisfy requirements of the present invention and had poor storage stability.

### Comparative Example 2

A toner was prepared in the same manner as in Example 1, except that the Resin A-1 was changed to a resin prepared in the same manner as in Synthesis Example 1 except that propylene glycol was used as alcohol components. Table 1 reports the properties of the resulting toner. As a result, the toner could not satisfy requirements of the present invention and had poor low-temperature fixing property.

### Comparative Example 3

A toner was prepared in the same manner as in Example 1, except that the resin A-1 was not used, i.e., the resin B-3 was only used. Table 1 reports the properties of the resulting toner. As a result, the toner could not satisfy requirements of the present invention and had poor low-temperature fixing property.

### Comparative Example 4

A toner was prepared in the same manner as in Example 1, except that the Resin A-1 was changed to a resin prepared in the same manner as in Synthesis Example 1 except that ethylene glycol was used as alcohol components, and an acid component ratio was isophthalic acid/trimellitic acid=97/3. Table 1 reports the properties of the resulting toner. As a result, the toner could not satisfy requirements of the present invention and had poor storage stability and blocking resistance.

### Comparative Example 5

A synthesis of a resin was attempted in the same manner as in Synthesis Example 2 except that acid components were composed of 10 mol % of 5-sulfoisophtalic acid, 37.5 mol % of isophtalic acid, 50 mol % of adipic acid, and 2.5 mol % of trimellitic anhydride. However, gelling occurred in a reaction container, and subsequent steps could not be carried out.

### —Molecular Weight—

Apparatus: GPC (manufactured by Tosho Corp.)

Detection apparatus: RI

Measurement temperature: 40° C.

Mobile phase: tetrahydrofuran

Flow rate: 0.45 mL/min

A molecular weight Mn and Mw, and a molecular weight distribution Mw/Mn mean a number average molecular weight and a weight average molecular weight, respectively, measured using gel permeation chromatography (GPC) when the calibration curve was constructed according to a polystyrene standard sample having a predetermined molecular weight. Tandemly connected three columns having the exclusion limit of 60,000, 20,000, and 10,000, respectively, were used.

### —Softening Point—

Using an elevated flow tester (for example, CFT-500D manufactured by Shimadzu Corp.), 1 g of a measurement sample was preheated at 50° C., and pushed through a nozzle having a diameter of 0.5 mm and a length of 1 mm by application of a load of 30 kg by means of a plunger while heating at a temperature rising rate of 5° C./min. A relation between “plunger descending amount (flow value)” and “temperature” was graphically illustrated, and a temperature corresponding to a half (½) of the maximum value of descending amount of the plunger was read from the graph, and the value (temperature at which a half of the measurement sample flows out) was determined as a softening point.

### —Glass Transition Temperature—

For 5 mg of a particulate toner loaded in a T-Zero simple sealed pan, the glass transition temperature was measured with a differential scanning calorimeter (DSC, Q2000, manufactured by TA Instruments). As the first heating, the sample was heated from 40° C. to 150° C. at 10° C./min under nitrogen gas stream, and kept for 5 minutes. After that, the sample was quenched to −70° C., and kept for 5 minutes. The sample was then heated at 5° C./min as the second heating. A thermal change was measured, and the relation between “endothermic and exothermic amount” and “temperature” resulting from the measurement was graphically illustrated. A characteristic inflection point observed in the graph was determined as Tg of the sample. Note that, the Tg was read from a DSC curve of the second heating by a midpoint method.

### —TMA %—

A tablet was made from 0.5 g of a particulate toner using 3 mm (in diameter) tablet forming apparatus (manufactured by Shimadzu Corp.) and was subjected to thermomechanical measuring apparatus (EXSTAR7000, manufactured by SII NanoTechnology Inc.). The tablet was heated from 0° C. to 180° C. at 2° C./min under nitrogen gas stream. The measurement was performed in a compression mode with a compression force of 100 mN. The relation between “sample temperature” and “compressive displacement (deformation rate)” resulting from the measurement was graphically illustrated, and a compressive displacement (deformation rate) corresponding to 50° C. was read from the graph, and the value was determined as a TMA %.

### —Evaluation of Blocking Resistance (Heat Resistant Storageability)—

A toner is supplied so as to fill a glass container, left for 24 hours in a constant temperature bath at 50° C., cooled to 24° C., and then evaluated the extent of blocking (aggregation) according to the following criteria.

A: No blocking occurred.

B: Blocking occurred, but was easily dispersed by applying force. Practically problems will not occur.

C: Blocking occurred, and could not be easily dispersed by applying force.

### —Preparation of Carrier—

To 100 parts of toluene were added 100 parts of silicone resin (organo straight silicone), 5 parts of y-(2-aminoethyl)aminopropyl trimethoxysilane, and 10 parts of carbon black. The mixture was dispersed for 20 minutes using a homomixer to prepare a coating liquid for a resin layer. The coating liquid for a resin layer was applied over the surface of 1,000 parts of spherical magnetite particles having an average particle diameter of 50 μm using a fluidized bed type coater thereby obtaining a carrier.

### —Preparation of Developing Agent—

In a ball mill, 95 parts of the carrier was mixed with 5 parts of the toner to prepare a developing agent.

### —Fixing Temperature—

A test for copying was carried out on type 6200 paper (Ricoh Company Ltd.) using a copier (MF2200, manufactured by Ricoh Company Ltd.) in which a fixing part had been modified so as to have a TEFLON (registered trademark) roller as a fixing roller.

Specifically, a temperature at which cold offset would occur (lower limit temperature for fixing) and a temperature at which hot offset would occur (upper limit temperature for fixing) were determined by changing temperatures for fixing.

Conditions for evaluation of the lower limit temperature for fixing were as follows: linear speed for paper sending: 120 mm/sec to 150 mm/sec; pressure applied on surface: 118 kPa (1.2 kgf/cm²); and nip width: 3 mm.

Conditions for evaluation of the upper limit temperature for fixing were as follows: linear speed for paper sending: 50 mm/sec; pressure applied on surface: 196 kPa (2.0 kgf/cm²); and nip width: 4.5 mm.

A range between the cold offset temperature (lower limit temperature for fixing) and the hot offset temperature (upper limit temperature for fixing) is determined as a fixing temperature range.

A fixing property is practically preferable when the lower limit temperature for fixing is 115° C. or less, and the fixing temperature range is 70° C. or more.

### —Color Development Property—

An image having a density of 0.3 mg/cm² was made in the same manner as in the section “Fixing Temperature,” and then an ID value was determined using X-RITE938 (manufactured by X-Rite). A color development property of the image was evaluated according to the following criteria. The color development determined as pass when ID value was 1.4 or more.

A: ID value was more than 1.5.

B: ID value was from 1.4 to 1.5.

C: ID value was less than 1.4.

TABLE 1

| | | Ex. 1 | Ex. 2 | Ex. 3 | Ex. 4 | Ex. 5 | Ex. 6 |
|---|---|---|---|---|---|---|---|
| Resin A | Mn | 4,400 | 5,200 | 4,700 | 4,700 | 4,400 | 5,200 |
| | Mw | 23,000 | 22,000 | 24,000 | 24,500 | 23,000 | 22,000 |
| | Tg/° C. | 4.9 | −10 | −1.2 | 4.6 | 4.9 | −10 |
| | T½/° C. | 107 | 63 | 94.5 | 94 | 107 | 63 |
| Resin B | Mn | 2,400 | 2,400 | 2,400 | 2,400 | 3,500 | 3,500 |
| | Mw | 5,400 | 5,400 | 5,400 | 5,400 | 9,400 | 9,400 |
| | Tg/° C. | 48 | 48 | 48 | 48 | 67 | 67 |
| | T½/° C. | 110 | 110 | 110 | 110 | 126 | 126 |
| bTg − aTg | | 43.1 | 58 | 49.2 | 43.4 | 62.1 | 77 |
| Toner | Amount of Resin A % | 20 | 20 | 20 | 20 | 30 | 30 |
| | Tg/° C. | 41 | 29 | 40 | 41 | 49 | 45 |
| | T½/° C. | 113 | 111 | 112 | 115 | 115 | 115 |
| | T½ − Tg | 72 | 82 | 72 | 74 | 66 | 70 |
| | TMA % | 2.8 | 1.8 | 3.0 | 3.0 | 0.8 | 1.5 |
| | Lower limit temperature | 110 | 100 | 110 | 100 | 115 | 115 |
| | of fixing/° C. | | | | | | |
| | Fixing temperature range | 70 | 90 | 90 | 85 | 70 | 70 |
| | Heat resistant | A | B | B | A | A | A |
| | storageability | | | | | | |
| | Color development | B | A | B | A | B | A |
| | property | | | | | | |

| | | | | Comp. | Comp. | Comp. | Comp. |
|---|---|---|---|---|---|---|---|
| | | Ex. 7 | Ex. 8 | Ex. 1 | Ex. 2 | Ex. 3 | Ex. 4 |
| Resin A | Mn | 3,400 | 3,500 | 3,000 | 5,500 | None | 5,000 |
| | Mw | 30,000 | 33,000 | 16,500 | 43,000 | | 25,000 |
| | Tg/° C. | −36 | −32 | 4.3 | 56 | | −41 |
| | T½/° C. | 79 | 110 | 80 | 150 | | 60 |
| Resin B | Mn | 2,400 | 2,400 | 2,400 | 2,400 | 4,000 | 2,400 |
| | Mw | 5,400 | 5,400 | 5,400 | 5,400 | 14,000 | 5,400 |
| | Tg/° C. | 48 | 48 | 48 | 48 | 29 | 48 |
| | T½/° C. | 110 | 110 | 110 | 110 | 90 | 110 |
| bTg − aTg | | 84 | 80 | 44 | −8 | 0 | 89 |
| Toner | Amount of Resin A % | 20 | 20 | 20 | 17.5 | 0 | 15 |
| | Tg/° C. | 27 | 32 | 40 | 50 | 32 | 17 |
| | T½/° C. | 105 | 109 | 105 | 143 | 91 | 85 |
| | T½ − Tg | 78 | 77 | 65 | 93 | 59 | 68 |
| | TMA % | 2.3 | 2.8 | 17 | 2.2 | 8 | 18 |
| | Lower limit temperature | 100 | 100 | 110 | 145 | 135 | 110 |
| | of fixing/° C. | | | | | | |
| | Fixing temperature range | 60 | 70 | 55 | 55 | 40 | 50 |
| | Heat resistant | B | A | C | A | B | C |
| | storageability | | | | | | |
| | Color development | A | A | B | A | C | C |
| | property | | | | | | |

As can be understood from Table 1, the toners of Examples 1 to 8 had satisfying properties in terms of all of the following factors: a lower limit temperature of fixing, a fixing temperature range, and blocking resistance, because all of the following values were within the desired range: a difference between a grass transition point of Resin A and that of Resin B, a difference between a softening point (T1/2) of the toner and a grass transition point (Tg) of the toner, and TMA compressive deformation rate (TMA %) at 50° C.

In contrast to, the toners of Comparative Examples 1 to 4 did not have satisfying properties in terms of all of the following factors: a lower limit temperature of fixing, a fixing temperature range, and blocking resistance, because any of the following values was not within the desired range: a difference between a grass transition point of Resin A and that of Resin B, a difference between a softening point (T1/2) of the toner and a grass transition point (Tg) of the toner, and TMA compressive deformation rate (TMA %) at 50° C. Practically problems will occur in an image forming apparatus even when only one property among above-mentioned properties is not satisfied.

This application claims priority to Japanese application No. 2011-041922, filed on Feb. 28, 2011 and Japanese application No. 2011-088036, filed on Apr. 12, 2011, and incorporated herein by reference.

What is claimed is:

1. An electrostatic image forming toner comprising:
a colorant;
a binder resin; and
a releasing agent,
wherein the binder resin contains at least two types of polyester resins A and B,
wherein a difference of (T1/2−Tg) is 65° C. or more but less than 90° C., where T1/2 denotes a softening point of the electrostatic image forming toner and Tg denotes a glass transition temperature of the electrostatic image forming toner, and
wherein the electrostatic image forming toner has a TMA compressive deformation rate (TMA %) at 50° C. which is 5% or less.

2. The electrostatic image forming toner according to claim 1, wherein the polyester resin A comprises a nonlinear reactive precursor “a” and a curing agent, wherein the polyester resin B is a linear polyester resin, and wherein a difference of (bTg−aTg) is 40° C. or more but less than 95° C., where aTg denotes a glass transition temperature of an active end capped product of the reactive precursor “a” and bTg denotes a glass transition temperature of the polyester resin B.

3. The electrostatic image forming toner according to claim 1, wherein the polyester resin A comprises 5-sulfoisophtalic acid backbone in proportion of 0.1 mol % to 10 mol % of the total acid components.

4. The electrostatic image forming toner of claim 1, wherein an amount of the polyester resin A in the binder resin is 1% by mass or more and 30% by mass or less.

5. A resin for use in a toner, the resin comprising:
at least two types of polyester resins A and B,
wherein the polyester resin A comprises a nonlinear reactive precursor “a” and a curing agent, wherein the polyester resin B is a linear polyester resin, and wherein a difference of (bTg−aTg) is 40° C. or more but less than 95° C., where aTg denotes a glass transition temperature of an active end capped product of the reactive precursor “a” and bTg denotes a glass transition temperature of the polyester resin B.

6. The resin for use in a toner according to claim 5, wherein an amount of the polyester resin A in the binder resin is 1% by mass or more and 30% by mass or less.
